(19) United States
(12) Patent Application Publication
(10) Pub. No.: US 2013/0079973 A1
(43) Pub. Date: Mar. 28, 2013

(54) System for Communicating A Vehicle Position and Speed During Accident

(71) Applicants: Nazar Elfadil Mohamed, Tabuk (SA); Sultan Hamadi Aljahdali, Taif (SA); Mohammed Moawad Alenazi, Rafha (SA)

(72) Inventors: Nazar Elfadil Mohamed, Tabuk (SA); Sultan Hamadi Aljahdali, Taif (SA); Mohammed Moawad Alenazi, Rafha (SA)

(73) Assignee: Taif University

(21) Appl. No.: 13/621,203

(22) Filed: Sep. 15, 2012

Related U.S. Application Data
(60) Provisional application No. 61/538,862, filed on Sep. 24, 2011.

(51) Int. Cl. B60R 21/0132

(52) U.S. Cl. 701/32.2

(57) ABSTRACT

A system includes a microcontroller, modem, nock sensor, and speed selection box is used to send messages when a certain speed has been exceeded and when an accident has occurred and the resulting speed of the vehicle is less than a predetermined threshold. The message sent can be a text message sent over a GSM modem.

### CROSS-REFERENCE TO RELATED APPLICATIONS

This application claims the benefit of the filing date of provisional application number 61,538,862, filed on Sep. 24, 2011. The contents of the provisional application are incorporated by reference in its entirety.

### BACKGROUND OF THE INVENTION

1. Field of Invention

The present invention relates to an accident detection and prevention system, and particularly relates to a system that sends a message to designated parties when a certain speed has been detected and when an accident has been detected with a resulting speed below a certain threshold. The present invention also relates to a method that may implement the system which notifies parties when a certain speed has been exceeded and when an accident occurs with a resulting speed below a certain level.

2. Related Art

In many locations, the number of vehicle accidents increases every year. The accidents are due to any number of factors, including, but not limited to: vehicle malfunction, road maintenance, and human error. Since the reasons for an accident vary to such a large extent, the community has found it difficult to develop a standard system to reduce or prevent all forms of accidents. Human error accounts for the vast majority of accidents. Therefore, it would be favorable to develop ways to reduce or prevent such errors.

Human error can be classified in two forms. The first form involves errors that occur before driving. Such errors include negligence, poor maintenance, and lack of driving skills. The second form of human error involves errors that occur during driving. These errors include, but are not limited to, not wearing seat belts, speeding, inattention, alcohol, drugs, and utilizing mobile devices. The human errors from the second category often results in more damaging accidents.

When an accident occurs, emergency services are not automatically notified. This delays typically results in increased severity of the injury and lessens the chance of recovery. As such, it is desirable to implement a system that informs emergency responders of the accident. It is further desirable to inform emergency services of the type of error and the potential severity of the error.

There have been some attempts to develop a system which helps solve this problem, though they have numerous shortcomings. One such system was proposed by Albert Montague (U.S. Pat. No. 6,642,844). The system uses a global positioning system (GPS) to determine the location of a vehicle in need. The location is used to route the distress call, via a mobile telephone, to the nearest emergency responder. The emergency responder is chosen by a fleet management system. If the nearest responder does not reply within a fixed amount of time, the call will automatically be routed to the next nearest responder. A potential draw back to this system is that it relies entirely on the mobile service in the area of the accident and the location of the emergency responder. If the accident occurs in a remote location without adequate cellular service, the system will not function. Okada (U.S. Pat. No. 6,166,656) claims to improve the Montague system by including an accident detection means, a vehicle location estimation system, and an external communication means of notifying the nearest emergency service provider. Despite these potential improvements, the system would most likely fail in remote areas.

### SUMMARY OF INVENTION

In one aspect, a vehicle notification and prevention device is provided in the present invention, and the device comprises a microcontroller, a nock sensor electrically connected to the microcontroller, a speed selection box electrically connected between the microcontroller, a modem electrically connected to the microcontroller, and a system reset button electrically connected to the microcontroller. The speed selection box assists in determining the speed of the vehicle. The speed can be measured by means such as GPS or engine pulses. A GPS may also be added to provide positioning information. The system may further comprise an alarm, such as an LED.

In another aspect, a method is implemented using the above device according to the present invention. A modem, such as a GSM modem, is initialized. The speed of the vehicle is also measured. An accident takes place during the method. If an accident has occurred, then a message will be sent. If an accident has occurred and a message has been sent, then the system will wait for the rest. The system may also send a message if a certain predetermined speed is exceeded.

In yet another aspect, a GSM modem is initialized. A speed measurement is taken to determine if the vehicle exceeds a third predefined. A determination is made to discover the presence of an accident. If an accident has occurred, the speed needs to be remeasured. If the speed is above a certain limit, then a message is send and the system waits for the rest. If the speed is below a certain limit, a message will be sent and an alarm will be activated. The system will then wait for reset.

### BRIEF DESCRIPTION OF THE DRAWINGS

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 shows an embodiment of the circuit layout of the system used in the present invention; and

FIG. 2 is a flow chart of the method described below, including various optional sub-steps and alternative routes depending on various conditions.

### DETAILED DESCRIPTION

In cooperation with the attached drawings, the technical contents and detailed description of the present invention are described thereinafter according to a preferable embodiment, being not used to limit its executing scope. Any equivalent variation and modification made according to appended claims is covered by the claims claimed by the present invention.

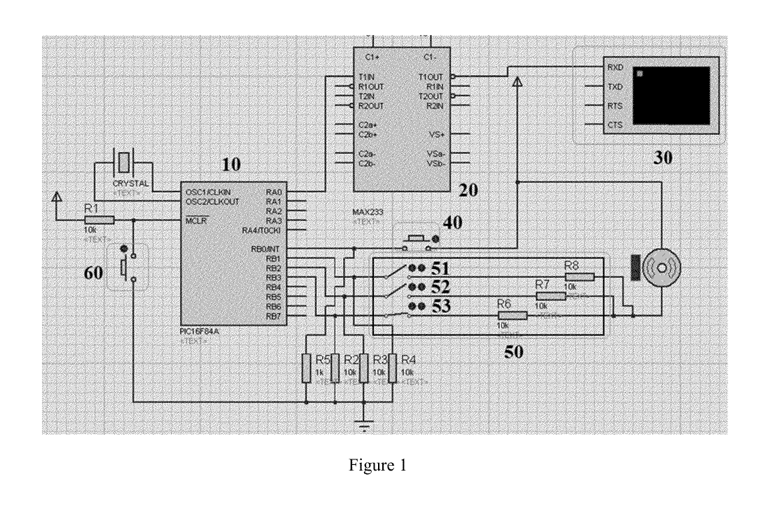

FIG. 1 depicts an embodiment of the circuit employed in the current system. The circuit further includes a peripheral interface controller (PIC) microcontroller 10, MAX233 20, and a GSM modem 30. The circuit further includes a plurality of resistors R1˜R8, capacitors C, diodes D, and various integrated circuits. Electrically connected to the PIC microcontroller 10 and a speed selection box 50 is a nock sensor 40. In this embodiment the PIC microcontroller 10 is a PIC16F84A. The nock sensor 40 is a sensor that detects when the vehicle has been stuck, thereby indicating an accident. The nock 40 may be any sensor, such as a crush sensor, but is preferably a predefined, handmade crush sensor. The crush sensor can be a handmade sensor. The crush sensor can be build out of a spring, ring, and rod. The sensitivity of such a sensor would depend on such factors as the size of the ring and the spring constant. In addition to the crush sensor, another nock sensor can be added. The number of sensors can be increased or decreased depending on such factors as economics for desired safety. For convenience, the nock sensor 40 is depicted as a switch. This is not to be taken as limiting the nock sensor 40 to a switch.

A speed selection box 50 is electrically connected to the PIC microcontroller 10 and the nock sensor 40. The speed selection box 50 contains a plurality of speed selection units 51, 53, 55. It is preferable that the system contain at least three speed selection units 51, 53, 55. The speed selection units 51, 53, 55 allow a user to select a speed with the system is programmed to monitor the speed. The speed selection units 51, 53, 55 are depicted as switches for convenience and ease of understanding. It should be noted that these speed selection units 51, 53, 55 are not actual switches. They represent the various voltage outputs of the corresponding voltage regulators, described below. The speed selection box 50 operates under Ohm's law. The current of the system depends on the resistance values. As the speed of the vehicle changes, the resistance within the circuit will change.

In FIG. 1, there are three speed selection units 51, 53, 55. Each voltage selection unit 51, 53 or 55 corresponds to a different vehicle speed. For example, the first voltage selection unit 51 could correspond to a speed of 50 Km/h, the second voltage selection unit 53 to a speed of 100 Km/h, and the third voltage selection unit 55 to a speed of 150 Km/h. Measuring speed is not limited to changes in voltage as the speed of the vehicle can be measured in various ways. An example of the ways the speed can be tested is by use of a tachometer. The speed can also be measured by counting the number of pulses generated by a gear box over a certain period of time. The number of pulses corresponds to the distance. When the distance is divided by time, speed can be obtained.

FIG. 1 depicts an embodiment of a system reset switch 60. The system reset switch 60 can be any type of switch that will allow a user to reset the program running within the circuit. After the user activates the system reset switch, the program will start from the beginning

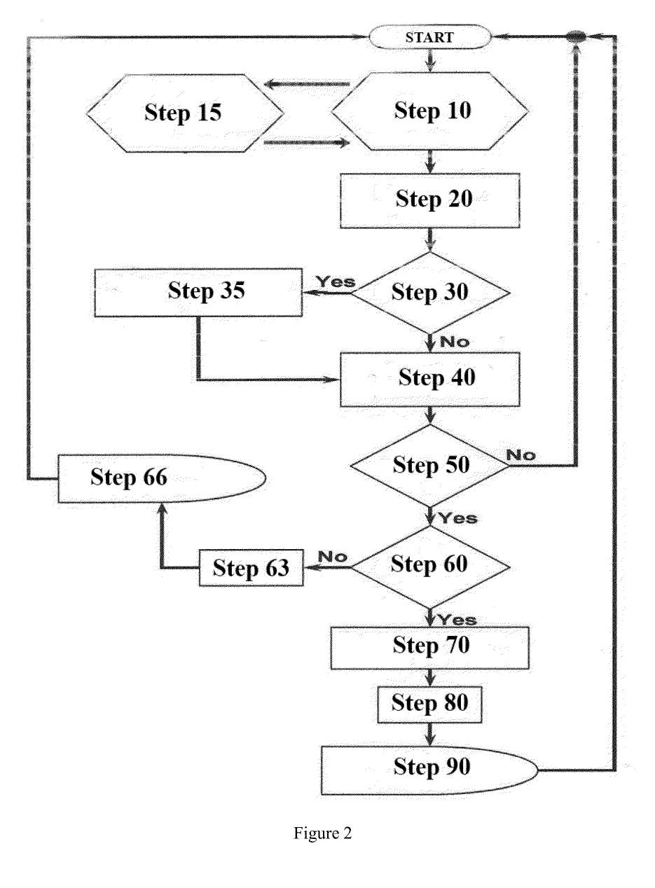

FIG. 2 depicts an embodiment of a flowchart depicting an accident notifications system. Step 10 indicated the initialization of a modem. The initialization can be started by the PIC microcontroller 10. The modem can be the GSM modem 30. During initialization of the GSM modem, the PIC microcontroller 10 may set up the GSM modem 30 by sending two AT commands. Worth to mention that commands always start with AT that stands for Attention. An example of the two AT commands sent are AT+CNMI and AT+CMGF are stands for command selects the procedure for message reception from the network. If these two signals are sent, the values for each signal can be AT+CNMI=2,1,0,0,1 and AT+CMGF=1. Near the time or at the same time of step 10, step 15 may occur. Step 15 is the initialization of a GPS device.

AT commands for GSM/GPRS wireless modems are several. In particular this section describes the AT-command based messages exchanged between a vehicle that commit accidents and rescue/emergency units. Table 1 below contains some information about commands that will be used by the proposed system.

TABLE 1
Some AT commands that utilized by the proposed system

| No | Command syntax |
|---|---|
| 1 | AT+CMGF=1 |
| | This is for setting text mode, while expected response is either OK |
| | that means TEXT mode is valid or not valid |
| 2 | AT+CNMI=2,2,0,0,0 |
| 3 | AT+CNMA |
| | which means acknowledge the message received, while expected |
| | response is OK when appositive send is acknowledge else is not OK |
| 4 | AT+CMGF=0 |
| | It means Set PDU mode. Expected response will be OK if PDU mode |
| | is valid otherwise is not OK |

In this embodiment, after the initialization step(s), the speed is measured (step 20). The speed will be placed into three categories. The first category is below a first predetermined speed, for example 50 Km/h. The second category is above the first predetermined speed and below a second predetermined speed, for example above 50 Km/h and below 119 Km/h. The third category is above a third predetermined speed, for example 120 Km/h. Step 30 determines if the measured speed falls within the third category. If so, then a message is sent in step 35. The message sent may be a text message sent via the GSM modem. The message contains the information that the speed has exceeded the third predetermined speed.

Step 40 detects if an accident has occurred. Detection means can be any means which may detect that an accident has occurred. For example, a crush sensor may be implemented to show an accident has occurred. During the accident detection step, the system will determine if the speed is outside the first category (step 60) and if the accident occurred (step 50). If no accident is detected, the system is reset. If an accident occurs and the speed falls within the first category, then an alarm will be activated (step 63). An example of the type of alarm that may be used is an LED. A further example of the alarm is a red LED. After the alarm is sent, the system will wait for reset (step 66). Reset can occur automatically or by physical action of a user. If the speed falls within a category other than the first category and an accident is detected, a message will be sent (step 70). The message can be sent via text message over the GSM modem. After sending the message (step 70), the alarm will be activated (step 80). The alarm can be an LED, for example. The message sent in step 70 includes information indicating that an accident has occurred and the speed category at the time of accident.

If the GPS unit has been included within the system, then the message may also contain the coordinates of the accident site. In this embodiment, the PIC microcontroller 10 would detect the accident and send a special AT command to the GPS module. This command would cause a reading of the GPS coordinates and relay it to the PIC microcontroller 10. The PIC microcontroller 10 would then send include the coordinates in the message and relay them to rescue staff. The GPS module could also be used to determine the speed of the vehicle, which could then be relayed to the rescue staff.

While the invention has been described according to what is presently considered to be the most practical and preferred embodiments, it must be understood that the invention is not limited to the disclosed embodiments. Those ordinarily skilled in the art will understand that various modifications and equivalent structures and functions may be made without departing from the scope of the invention as defined in the claims. Therefore, the invention, as defined in the claims, must be accorded the broadest possible interpretation so as to encompass all such modifications and equivalent structures and functions.

What is claimed is:

1. A vehicle accident notification and prevention device, comprising:
a microcontroller;
a nock sensor electrically connected to the microcontroller;
a speed selection box electrically connected to the microcontroller;
a modem electrically connected to the microcontroller; and
a system reset button electrically connected to the microcontroller.

2. The vehicle accident notification and prevention device described in claim 1, further comprising an alarm connected to the microcontroller.

3. The vehicle accident notification and prevention device described in claim 2, wherein the alarm is a light emitting diode.

4. The vehicle accident notification and prevention device described in claim 1, further comprising a global positioning device connected to the microcontroller.

5. The vehicle accident notification and prevention device described in claim 4, wherein the global positioning device functions as the speed selection box and may function as a positioning device.

6. The vehicle accident notification and prevention device described in claim 1, wherein the modem is a GSM modem.

7. The vehicle accident notification and prevention device described in claim 1, wherein the microcontroller is a PIC microcontroller.

8. The vehicle accident notification and prevention device described in claim 1, wherein the speed selection box allows a user to select at least three speeds, for which a system monitoring such speeds would respond differently to each of the speeds.

9. The vehicle accident notification and prevention device described in claim 1, wherein the speed selection box determines speed based on Ohm's Law.

10. The vehicle accident notification and prevention device described in claim 1, wherein the speed selection box determines speeds by calculating the number of pulses generated from a gear box.

11. A method of preventing and determining a vehicle accident, comprising the steps of:
initializing a modem;
measuring a first speed of a vehicle;
determining if an accident has occurred;
sending a message if an accident has occurred; and
waiting for system reset.

12. The method of preventing and determining a vehicle accident described in claim 11, wherein the message is sent via a GSM modem.

13. The method of preventing and determining a vehicle accident described in claim 11, further comprising the step of sending a message if the first measured speed of the vehicle is above a first predetermined speed.

14. The method of preventing and determining a vehicle accident described in claim 11, further comprising the step of measuring a second speed at approximately the same time as the accident determination step.

15. The method of preventing and determining a vehicle accident described in claim 14, wherein the sending message step occurs if the second measured speed is below a second predetermined speed.

16. The method of preventing and determining a vehicle accident described in claim 15, further comprising the step of activating an alarm at approximately the same time the message is sent.

17. The method of preventing and determining a vehicle accident described in claim 14, further comprising the step of activating an alarm if step of measuring a second speed determines the speed is at or above a second predetermined speed.

18. The method of preventing and determining a vehicle accident described in claim 11, further comprising the step of activating an alarm.

19. The method of preventing and determining a vehicle accident described in claim 11, further comprising the step of initializing a global positioning device.

20. A method of preventing and determining a vehicle accident, comprising the steps of:
initializing a GSM modem;
measuring a first speed of a vehicle to determine if the speed is above a third predefined speed and sending a message if the speed has exceed such a third predefined speed;
determining if an accident has occurred;
determining if the speed of the vehicle is greater than or equal to a first predetermined speed if an accident has occurred;
sending a message if an accident has occurred;
activating an alarm if an accident has occurred; and
waiting for system reset.
